(19) United States
(12) Patent Application Publication
(10) Pub. No.: US 2009/0023305 A1
(43) Pub. Date: Jan. 22, 2009

(54) MULTIPLE USE ELECTRIC CURRENT CONNECTOR ASSEMBLY FOR VEHICLES

(75) Inventors: Mark D. KORICH, Chino Hills, CA (US); Young DOO, La Palma, CA (US); Mark L. SELOGIE, Manhattan Beach, CA (US)

Correspondence Address: INGRASSIA FISHER & LORENZ, P.C. (GM), 7010 E. COCHISE ROAD, SCOTTSDALE, AZ, 85253, US

(73) Assignee: GM GLOBAL TECHNOLOGY OPERATIONS, INC., DETROIT, MI (US)

(21) Appl. No.: 12/171,835

(22) Filed: Jul. 11, 2008

Related U.S. Application Data
(60) Provisional application No. 60/950,296, filed on Jul. 17, 2007.

(51) Int. Cl. H01R 33/00

(52) U.S. Cl. 439/34

(57) ABSTRACT

An electric current connector assembly for a vehicle includes a first connector and a second connector. The first connector comprises a first end portion of a first busbar and a first end portion of a second busbar. The second connector is electrically coupled to the first connector. The second connector comprises a second end portion of the first busbar and a second end portion of the second busbar.

### CROSS-REFERENCES TO RELATED APPLICATIONS

This application claims the benefit of U.S. Provisional Application No. 60/950,296, filed Jul. 17, 2007 (the entire content of which is incorporated herein by reference).

### TECHNICAL FIELD

The subject matter described herein generally relates to electric assemblies, and more particularly relates to electric current connector assemblies for use in vehicles.

### BACKGROUND OF THE INVENTION

Hybrid electric, fully electric, fuel cell, and other fuel efficient vehicles are becoming increasingly popular. Electric and hybrid electric vehicles utilize high voltage battery packs or fuel cells that deliver direct current necessary to drive electric traction systems and/or other vehicle systems. These vehicles use thick electric current busbars as electric current inputs or electric current outputs to deliver high power direct current from battery packs, fuel cells, and/or other power sources to electric motors and/or other electric devices and/or systems of the vehicle.

However, the number of inputs or outputs required for such delivery of high power electric current may vary depending, at least in part, on the type of vehicle. For example, in a fuel cell vehicle, two electric current inputs may be required to receive the high power direct electric current from a fuel cell of the fuel cell vehicle. As another example, in an electric vehicle, two electric current inputs may be required to receive the high power direct electric current from a battery of the electric vehicle. As yet another example, in a hybrid vehicle, a single electric current input may be required to receive the high power direct electric current from a battery of the hybrid vehicle, while a nearby electric current output may also be required to transport the high power direct electric current to an air conditioning compressor and/or another system or device of the hybrid vehicle.

Typically, such different types of vehicles and vehicle systems with different needs for electric current inputs and/or outputs require different and/or specialized electric current connection assemblies. For example, the above-referenced exemplary fuel cell and electric vehicles require a first type of electric current connector assembly having two nearby electric current inputs, while the above-referenced exemplary hybrid vehicle requires a second type of electric current connector assembly having one electric current input along with one nearby electric current output. The need for such different types of electric current connection assemblies with different numbers of nearby electric current inputs and/or electric current outputs can lead to increased design, manufacturing, and/or supply costs for the different electric current connection assemblies. In addition, if a common electric current connector assembly were designed with extra, unnecessary inputs or outputs, this could also result in increased design, manufacturing, and supply costs for the different electric current connection assemblies and in increased space and weight for the vehicles and vehicle systems.

Accordingly, it is desired to provide improved electric current connection systems that can be used in connection with different types of vehicles and/or vehicle systems with different electric current input and electric current output needs. It is also desirable to provide improved electric current connection systems that do not include unnecessary inputs and/or outputs that result in significantly increased space and/or weight in the vehicles and vehicle systems. In addition, it is desirable to provide improved electric current connection systems that potentially result in decreased design, manufacturing, and supply costs for the electric current connection system and for the vehicles and vehicle systems for which the electric current connection system is utilized.

Furthermore, other desirable features and characteristics of the present invention will be apparent from the subsequent detailed description and the appended claims, taken in conjunction with the accompanying drawings and the foregoing technical field and background.

### SUMMARY OF THE INVENTION

In accordance with an exemplary embodiment of the present invention, an electric current connector assembly for a vehicle is provided. The electric current connector assembly comprises a first connector and a second connector. The first connector comprises a first end portion of a first busbar and a first end portion of a second busbar. The second connector is electrically coupled to the first connector. The second connector comprises a second end portion of the first busbar and a second end portion of the second busbar.

In accordance with another exemplary embodiment of the present invention, another electric current connector assembly for a vehicle is provided. The electric current connector assembly comprises a first busbar and a second busbar. The first busbar at least partially forms a first connector and a second connector, and extends therebetween. The second busbar also at least partially forms the first and second connectors, and also extends therebetween.

In accordance with a further exemplary embodiment of the present invention, yet another electric current connector assembly for a vehicle is provided. The electric current connector assembly comprises a first connector, a second connector, a first insulator, and a second insulator. The first connector comprises a first end portion of a battery positive busbar and a first end portion of a battery negative busbar. The second connector is electrically coupled to the first connector. The second connector comprises a second end portion of the battery positive busbar and a second end portion of the battery negative busbar. The first insulator is disposed between the first and second end portions of the battery positive busbar. The second insulator is disposed between the first and second end portions of the battery negative busbar. The first connector and the second connector are each operable as an electric current input or as an electric current output.

### BRIEF DESCRIPTION OF THE DRAWINGS

The present invention will hereinafter be described in conjunction with the following drawing figures, wherein like numerals denote like elements, and wherein:

FIG. 1 is a functional block diagram of an electric current connector assembly having two electric current connectors disposed at least partially within a housing, in accordance with an exemplary embodiment of the present invention;

FIG. 2 is a cross-sectional view of a portion of the electric current connector assembly of claim 1, including the two electric current connectors thereof, and depicting busbars and insulators thereof, in accordance with an exemplary embodiment of the present invention; and

FIG. 3 is a perspective view of a portion of the electric current connector assembly of claim 1, including the two electric current connectors thereof of FIGS. 1 and 2 and including the busbars and insulators thereof as depicted in FIG. 2, and shown as electrically coupled to an exemplary circuit board and an exemplary common mode choke, in accordance with an exemplary embodiment of the present invention.

### DETAILED DESCRIPTION OF THE INVENTION

The following detailed description is merely exemplary in nature, and is not intended to limit the invention or the application and uses of the invention. Furthermore, there is no intention to be bound by any expressed or implied theory presented in the preceding technical field, background, brief summary or the following detailed description.

Embodiments of the invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present invention may be practiced in conjunction with any number of different devices and/or systems for any number of different types of vehicles.

Also, for the sake of brevity, conventional techniques related to signal processing, data transmission, signaling, control, and other functional aspects of the systems (and the individual operating components of the systems) may not be described in detail herein. Furthermore, the Figures contained herein are intended to represent exemplary placements, functional relationships, and/or physical couplings between various elements. It should be noted that many alternative or additional functional relationships or physical connections may be present in a practical embodiment.

Furthermore, the Figures contained herein are intended to represent exemplary placements, functional relationships, and/or physical couplings between various elements. It should be noted that many alternative or additional functional relationships or physical connections may be present in a practical embodiment.

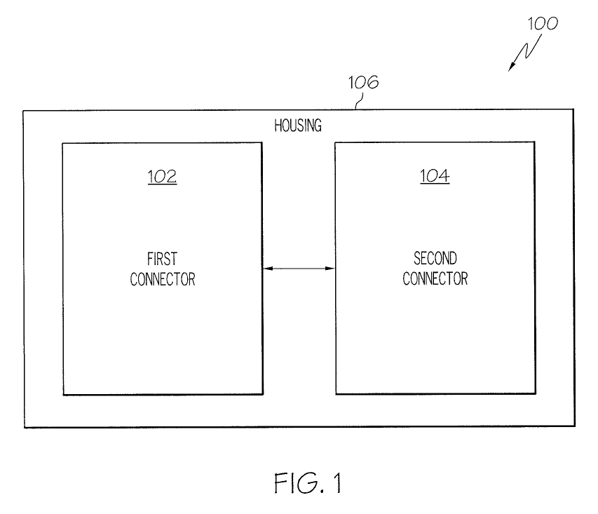

FIG. 1 is a functional block diagram of an electric current connector assembly 100 for use in a vehicle, in accordance with an exemplary embodiment of the present invention. The vehicle may be any one of a number of different types of automobiles, such, as, by way of example only, a sedan, a wagon, a truck, a van, a sport utility vehicle (SUV), or any one of a number of other different types of automobiles or other vehicles. The vehicle may also include any one or more different types of engines, such as, by way of example only, a gasoline or diesel fueled combustion engine, a flex fuel vehicle (FFV) engine that uses a mixture of gasoline and alcohol, a gaseous compound engine that uses a gaseous compound such as hydrogen and natural gas, a combustion/electric motor hybrid engine, an electric motor, and a fuel cell motor.

As depicted in FIG. 1, the electric current connector assembly 100 includes a first connector 102 and a second connector 104 that are preferably electrically coupled to one another. As used herein, unless expressly stated otherwise, “coupled” means that one element or feature is directly or indirectly joined to (or directly or indirectly communicates with) another element or feature, and not necessarily mechanically.

Each of the first and second connectors 102, 104 is operable to receive and/or transport electric current. Specifically, in a preferred embodiment, each of the first and second connectors 102, 104 is operable to receive and transport high power direct electric current from two or more devices and/or systems of the vehicle.

Also as depicted in FIG. 1, the first connector 102 and second connector 104 are both housed at least partially within a common housing 106 in one exemplary embodiment. However, this may vary in other embodiments. In certain other embodiments, the electric current connector assembly 100 may also include additional connectors and/or other features.

In a preferred embodiment, each of the first and second connectors 102, 104 is operable as an electric current input or as an electric current output. In a most preferred embodiment, each of the first and second connectors 102, 104 is operable for dual usages. Specifically, the first connector 102 is preferably operable for use as an electric current input for certain types of vehicles and/or vehicle systems and/or at different points in time, and for use as an electric current output for certain other types of vehicles and/or other vehicle systems and/or at other different points in time. Similarly, the second connector 104 is likewise preferably operable for use as an electric current input for certain types of vehicles and/or vehicle systems and/or at different points in time, and for use as an electric current output for certain other types of vehicles and/or other vehicle systems and/or at other different points in time.

For example, when the electric current connector assembly 100 is installed in a fuel cell vehicle that requires two electric current inputs to receive high power direct electric current from a fuel cell of the fuel cell vehicle, then both the first connector 102 and the second connector 104 are preferably used as inputs to jointly receive high power direct electric current from the fuel cell. Similarly, when the electric current connector assembly 100 is installed in an electric vehicle that requires two electric current inputs to receive high power direct electric current from a battery of the electric vehicle, then both the first connector 102 and the second connector 104 are preferably used as inputs to jointly receive high power direct electric current from the battery.

Conversely, when the electric current connector assembly 100 is installed in a hybrid vehicle that requires a single electric current input to receive high power direct electric current from a battery of the hybrid vehicle and that also requires a nearby electric current output to transport the high power direct electric current to an air conditioning compressor and/or one or more other devices and/or systems requiring direct electric current, then the first connector 102 is preferably used as an electric current input to receive high power direct electric current from the battery while the second connector 104 is preferably used as an electric current output to transport high powered direct electric current to the air conditioning compressor and/or one or more other devices and/or systems requiring direct electric current.

In yet another example, the first connector 102 can be used as an electric current input at a first point in time (designated, for example, as time zero (t₀)) and as an electric current output at a second point in time (designated, for example, as time one (t₁)) in certain embodiments. Similarly, in certain embodiments, the second connector 104 can be used as an electric current input at one point in time (designated, for example, as time two (t₂), which may or not be equal to time t₁ or time t₀ in various embodiments) and as an electric current output at another point in time (designated, for example, as time three (t₃), which may or not be equal to time t₁ or time t₀ in various embodiments).

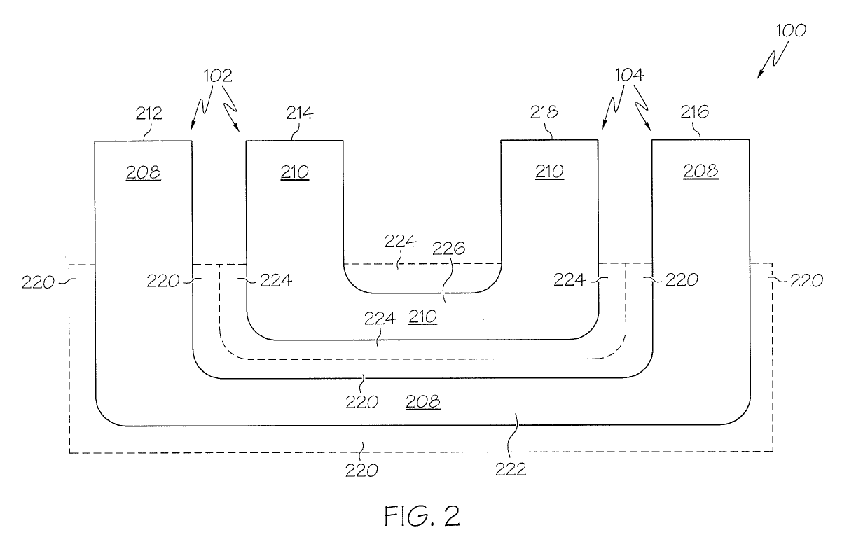

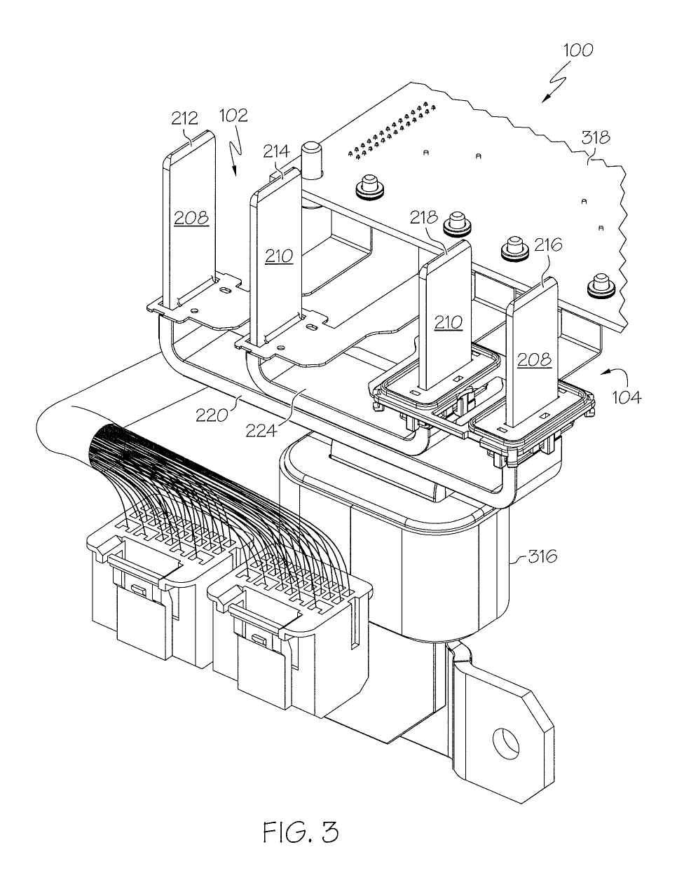

In various other embodiments, the first and second connectors 102, 104, and/or any additional connectors included within the electric current connector assembly 100, may have other criteria and/or factors governing such dual uses as electric current inputs and electric current outputs, for example pertaining to other types of vehicles and/or vehicle systems, other points in time, the occurrence of one or more operating conditions and/or other events, and/or one or more other types of criteria and/or categories. As will be described in greater detail below in connection with FIGS. 2 and 3, the first connector 102 and the second connector 104 are formed by two shared busbars in a configuration that allows for such operating flexibility and for the dual uses for each of the first and second connectors 102, 104 as an electric current input or as an electric current output.

FIG. 2 is a cross-sectional view of a portion of the electric current connection system 100 of FIG. 1, including the first and second electric current connectors 102, 104 thereof, in accordance with an exemplary embodiment of the present invention. As depicted in FIG. 2, the first connector 102 comprises a portion of first busbar 208 and also a portion of second busbar 210. Also as shown in FIG. 2, the second connector 104 also comprises a portion of a first busbar 208 and also a portion of a second busbar 210.

Specifically, in a preferred embodiment, the first connector 102 comprises a first end portion 212 of the first busbar 208 and a first end portion 214 of the second busbar 210. Also in a preferred embodiment, the second connector 104 comprises a second end portion 216 of the first busbar 208 and a second end portion 218 of the second busbar 210.

Accordingly, and as shown in FIG. 2, in the depicted embodiment the first busbar 208 and the second busbar 210 each at least partially form the first connector 102. Similarly, and as shown in FIG. 2, in the depicted embodiment, the first busbar 208 and the second busbar 210 likewise each at least partially form the second connector 104. In addition, and as also shown in FIG. 2, each of the first busbar 208 and the second busbar 210 extend between the first connector 102 and the second connector 104 in the depicted embodiment.

As depicted in FIG. 2, the first end portions 212, 214 of the first busbar 208 and the second busbar 210, respectively, are in relatively close proximity to one another as part of the first connector 102. Also as depicted in FIG. 2, the second end portions 216, 218 of the first busbar 208 and the second busbar 210, respectively, are also in relatively close proximity to one another as part of the second connector 104. Thus, in the depicted embodiment, the electric current connector assembly 100 includes first and second connectors 102, 104 that are each formed by respective opposing portions or ends of the first busbar 208 and the second busbar 210.

In a preferred embodiment, the first busbar 208 comprises a battery positive busbar and the second busbar 210 comprises a battery negative busbar. Each of the first and second busbars 208, 210 has an electrically conductive body, and each is configured to receive and/or transport electric current. In a preferred embodiment, each of the first and second busbars 208, 210 is configured to receive and transport high power direct electric current. In certain non-limiting embodiments, each of the first and second busbars 208, 210 can handle currents up to 200 amps. However, this may vary in other embodiments. Also in a preferred embodiment, each of the first and second busbars 208, 210 is made of copper or a copper alloy. However, this may also vary in other embodiments.

In addition, in a preferred embodiment, the electric current connector assembly 100 also includes a first insulator 220 and a second insulator 224, for example as shown in FIG. 2. In a preferred embodiment, the first insulator 220 at least partially surrounds a portion of the first busbar 208 at one or more locations that are disposed between the first and second end portions 212, 216 of the first busbar 208. Specifically, as shown in FIG. 2, the first insulator 220 is preferably disposed around, and surrounding, a middle portion 222 of the first busbar 208 that is disposed between the first and second end portions 212, 216 of the first busbar 208, and thus between the first connector 102 and the second connector 104.

Also in a preferred embodiment, the second insulator 224 at least partially surrounds a portion of the second busbar 210 at one or more locations that are disposed between the first and second end portions 214, 218 of the second busbar 210. Specifically, as shown in FIG. 2, the second insulator 224 is preferably disposed around, and surrounding, a middle portion 226 of the second busbar 210 that is disposed between the first and second end portions 214, 218 of the second busbar 210, and thus between the first connector 102 and the second connector 104.

Together, the first and second insulators 220, 224 help prevent unwanted contacted between the first busbar 208 (which, as noted above, is preferably a battery positive busbar) and the second busbar 210 (which, as noted above, is preferably a battery negative busbar). It will be appreciated that in different embodiments various different types and/or numbers of insulators may be utilized.

FIG. 3 is a perspective view of a portion of the electric current connector assembly 100 of FIG. 1, including the first and second connectors 102, 104 thereof of FIGS. 1 and 2 and the first and second busbars 208 and 210 and the first and second insulators 220, 224 thereof of FIG. 2, which are shown with an exemplary common mode choke 316 and an exemplary circuit board 318, all in accordance with an exemplary embodiment of the present invention. As shown in FIG. 3, in one exemplary preferred embodiment, each of the first and second connectors 102, 104 is electrically coupled to both the common mode choke 316 and the circuit board 318 via the first and second busbars 208, 210.

In one preferred embodiment, the common mode choke 316 pulls electric current from the first and second busbars 208, 210, and also provides EMI filtering (for example, in conjunction with non-depicted filtering capacitors). For example, in one embodiment, the common mode choke 316 extends through the first and second insulators 220, 224 to receive current from the first and second busbars 208, 210. However, this may vary in other embodiments.

The circuit board 318 facilitates interfacing with one or more vehicle control systems and/or other vehicle devices and/or systems. For example, in various embodiments, the circuit board 318 may be electrically coupled to the first and second busbars 208, 210 via one or more metal attachments that can be soldered or otherwise affixed to the circuit board 318 and to the first and second busbars 208, 210. The circuit board 318 and the common mode choke 316 may be used as part of an inverter in certain exemplary embodiments. However, this may also vary in other embodiments.

Accordingly, improved electric current connector assemblies are provided. In a preferred embodiment, the disclosed electric current connector assemblies 100 include first and second connectors 102, 104 that are each formed by respective opposing portions of a battery positive first busbar 208 and a battery negative second busbar 210. The disclosed electric current connection systems 100 have the flexibility and versatility to be used in connection with different types of vehicles, vehicle systems, and/or environments with different electric current input and electric current output needs. In addition, the disclosed electric current connection systems 100 do not require unnecessary inputs and/or outputs to provide this versatile functionality for multiple types of vehicles, vehicle systems, and environments, and potentially results in decreased design, manufacturing, and/or supply costs for the electric current connection systems and/or for the vehicles and/or vehicle systems for which the electric current connection systems are utilized and potentially without requiring a significant increase in size and/or weight in the vehicles and/or vehicle systems.

It will be appreciated that the electric current connector assemblies in various embodiments can be implemented in connection with any number of different types of vehicles and in electrically coupling any number of different types of motors, devices, and/or systems thereof and/or in connection therewith. It will similarly be appreciated that various features and elements of the disclosed electric current connector assemblies may vary from those depicted in the Figures and/or described herein in certain embodiments.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. An electric current connector assembly for a vehicle, the electric current connector assembly comprising:
a first connector comprising a first end portion of a first busbar and a first end portion of a second busbar; and
a second connector electrically coupled to the first connector, the second connector comprising a second end portion of the first busbar and a second end portion of the second busbar.

2. The electric current connector assembly of claim 1, further comprising:
a first insulator disposed between the first and second end portions of the first busbar; and
a second insulator disposed between the first and second end portions of the second busbar.

3. The electric current connector assembly of claim 1, wherein:
the first busbar is a battery positive busbar; and
the second busbar is a battery negative busbar.

4. The electric current connector assembly of claim 1, further comprising:
a housing;
wherein the first connector and the second connector are disposed at least partially within the housing.

5. The electric current connector assembly of claim 1, wherein the first connector and the second connector are each operable as an electric current input or as an electric current output.

6. The electric current connector assembly of claim 5, wherein:
the vehicle has a fuel cell; and
the first connector and the second connector are each operable to receive electric current from the fuel cell.

7. The electric current connector assembly of claim 5, wherein:
the vehicle has a battery; and
the first connector and the second connector are each operable to receive electric current from the battery.

8. The electric current connector assembly of claim 5, wherein:
the vehicle has a battery and an air conditioning compressor;
the first connector is operable to receive electric current from the battery; and
the second connector is operable to supply electric current to the air conditioning compressor.

9. The electric current connector assembly of claim 1, wherein the first connector and the second connector are operable to be electrically coupled to a circuit board and to a common mode choke.

10. An electric current connector assembly for a vehicle, the electric current connector assembly comprising:
a first busbar at least partially forming a first connector and a second connector and extending therebetween; and
a second busbar also at least partially forming the first and second connectors and extending therebetween.

11. The electric current connector assembly of claim 10, further comprising:
a first insulator at least partially surrounding a middle portion of the first busbar between the first and second connectors; and
a second insulator at least partially surrounding a middle portion of the second busbar between the first and second connectors.

12. The electric current connector assembly of claim 10, wherein:
the first busbar is a battery positive busbar; and
the second busbar is a battery negative busbar.

13. The electric current connector assembly of claim 10, wherein the first connector and the second connector are each operable as an electric current input or as an electric current output.

14. The electric current connector assembly of claim 13, wherein:
the vehicle has a battery and an air conditioning compressor;
the first connector is operable to receive electric current from the battery; and
the second connector is operable to supply electric current to the air conditioning compressor.

15. The electric current connector assembly of claim 13, wherein:
the vehicle has a fuel cell; and
the first connector and the second connector are each operable to receive electric current from the fuel cell.

16. The electric current connector assembly of claim 13, wherein:
the vehicle has a battery; and
the first connector and the second connector are each operable to receive electric current from the battery.

17. An electric current connector assembly for a vehicle, the electric current connector assembly comprising:
a first connector comprising a first end portion of a battery positive busbar and a first end portion of a battery negative busbar;
a second connector electrically coupled to the first connector, the second connector comprising a second end portion of the battery positive busbar and a second end portion of the battery negative busbar;
a first insulator disposed between the first and second end portions of the battery positive busbar; and
a second insulator disposed between the first and second end portions of the battery negative busbar,
wherein the first connector and the second connector are each operable as an electric current input or as an electric current output.

18. The electric current connector assembly of claim 17, wherein:
the vehicle has a battery and an air conditioning compressor;
the first connector is operable to receive electric current from the battery; and
the second connector is operable to supply electric current to the air conditioning compressor.

19. The electric current connector assembly of claim 17, wherein:
the vehicle has a fuel cell; and
the first connector and the second connector are each operable to receive electric current from the fuel cell.

20. The electric current connector assembly of claim 17, wherein:
the vehicle has a battery; and
the first connector and the second connector are each operable to receive electric current from the battery.
